(19) United States
(12) Patent Application Publication
(10) Pub. No.: US 2009/0322879 A1
(43) Pub. Date: Dec. 31, 2009

(54) Method and device for the detection of defective pixels of an image recording sensor, preferably in a driver assistance system

(76) Inventors: Petko Faber, Renningen (DE); Dirk Schmid, Simmonzheim (DE)

Correspondence Address: KENYON & KENYON LLP, ONE BROADWAY, NEW YORK, NY, 10004, US

(21) Appl. No.: 12/308,195

(22) PCT Filed: Jul. 12, 2007
(86) PCT No.: PCT/EP2007/057186

§ 371 Date: Aug. 3, 2009

(30) Foreign Application Priority Data
Aug. 29, 2006 (DE) 102006040349.5

(51) Int. Cl. H04N 5/222; H04N 7/00

(52) U.S. Cl. 348/148; 348/246; 348/E07.091; 348/E05.022

(57) ABSTRACT

In a method and an apparatus for detecting defective pixels of an image acquisition sensor, preferably in a driver assistance system, brightness values are evaluated statistically for each pixel while the image acquisition sensor is being operated as intended for image acquisition, at least one comparable parameter being determined for statistical evaluation for each pixel from the ascertained brightness values, and that parameter being compared with at least one predefinable reference value; and a defective pixel being detected when the at least one parameter determined for the relevant pixel meets a predefinable condition with respect to the at least one reference value.

### FIELD OF THE INVENTION

The present invention relates to a method for detecting defective pixels of an image acquisition sensor, preferably in a driver assistance system.

### BACKGROUND INFORMATION

The existing art discloses a variety of driver assistance systems or vehicle systems, for example night vision devices, lane detection systems, road sign detection systems, reversing assistance systems, occupant detection systems, etc., that use electronic cameras having an image acquisition sensor. The image acquisition sensor is preferably embodied as a CCD or CMOS sensor chip that is evaluated, for image processing, by a high-performance computer unit. The image processing quality depends, among other factors, on the number of defective pixels or image points of the image acquisition sensor, which pixels at present cannot be detected by self-diagnosis during operation of the vehicle.

U.S. Pat. No. 6,683,643 describes an electronic camera that is capable of detecting defective pixels. For detection of the defective pixels, predefined images are acquired in a test mode with an image acquisition sensor of the electronic camera, which images are suitable for detecting defective pixels. For detection of the defective pixels of the image acquisition sensor, the image data of the predefined image that have been sensed by the individual pixels of the image acquisition sensor are compared with stored image data that represent reference values for the detection of defective pixels. The positions of detected defective pixels are stored in a memory. During normal operation of the camera, the image data furnished by the defective pixels are replaced, based on the stored position data, by corrected image data that are ascertained from the average values of image data, the average values being constituted from image data sensed by pixels disposed adjacent to the known defective pixels.

### SUMMARY

The method according to example embodiments of the present invention for detecting defective pixels of an image acquisition sensor, preferably in a driver assistance system, has, in contrast, the advantage that brightness values can be evaluated statistically for each pixel while the image acquisition sensor is being operated as intended for image acquisition. For statistical evaluation, at least one comparable parameter is determined for each pixel from the ascertained brightness values, and that parameter is compared with at least one predefinable reference value, a defective pixel being detected when the at least one parameter determined for the relevant pixel meets a predefinable condition with respect to the at least one reference value. The method according to example embodiments of the present invention can advantageously be continuously active in the background without influencing ongoing operation of the image acquisition sensor.

In order to carry out the method according to example embodiments of the present invention for detecting defective pixels of an image acquisition sensor in a camera system, an evaluation and control unit, connected to the image acquisition sensor, is used; said unit can encompass, for example, a high-performance computing unit for image processing that can be part of the relevant driver assistance system, so that economical implementation of the method according to example embodiments of the present invention without additional hardware is possible.

It is particularly advantageous that the parameters are determined from the sensed brightness values via time-sliding averaging by windowing with a constant or variable width and/or with recursive filtration, the determined parameters encompassing averages and/or maximum values and/or minimum values and/or maximum and/or minimum difference values and/or standard deviations.

In an example embodiment of the method for detecting defective pixels of an image acquisition sensor, a defective pixel is detected, for example, when the at least one parameter determined for the corresponding pixel reaches and/or exceeds a first predefined reference value, or reaches and/or falls below a second predefined reference value, the first predefined reference value corresponding to a maximum value and the second predefined reference value to a minimum value. This detection of defective pixels is based on the assumption that a defective pixel appears black or white, i.e. assumes an extreme dark or light value; and it can advantageously be carried out very simply and with relatively few computer resources. All pixels can therefore be checked, during image acquisition operation of the image acquisition sensor, as to whether they are continuously outputting image data that represent a black or white value.

Additionally or alternatively, a difference between chronologically successive identical parameters for each pixel can be evaluated, a defective pixel being detected when the ascertained difference reaches and/or falls below a predefined third reference value over a predefined period of time. This “simple” statistic advantageously makes possible an efficient procedure with few computer resources, and can be used even at night.

In an example embodiment of the method, for the detection of defective pixels of an image acquisition sensor, at least one ascertained parameter for each pixel is compared with the same at least one ascertained parameter of the adjacent pixels, a defective pixel being inferred when differences between the at least one ascertained parameter of the corresponding pixel, and the ascertained parameters of its adjacent pixels, reach and/or exceed a predefined fourth reference value. This detection of defective pixels is based on the postulate that a time dynamic of brightness fluctuations that act on the image acquisition sensor during image acquisition operation is approximately the same for directly adjacent pixels. It is assumed that this postulate is always true during normal vehicle operation because of the relative motion between vehicle and imaged scene, except when the vehicle is at a standstill.

For evaluation of the adjacent pixels it is possible to use, for example, an analysis window having a predefinable number of pixels, which is shifted in steps over an image region of the image acquisition sensor. This advantageously makes it possible to economize on computer resources. For example, a region of three pixels in one row or column can be used, which region is progressively shifted over the entire image region of the image acquisition sensor so that at the end of the pass, each pixel has been evaluated.

In an example embodiment of the method for detecting defective pixels of an image acquisition sensor, preferably in a driver assistance system, the image region of the image acquisition sensor can be divided, as a function of importance and/or of a rate of change to be expected, into different zones that are checked successively in a defined sequence. The importance of the image region results, for example, from its position, i.e. whether it is located at the center of the image or in the edge region of the image acquisition sensor. The rate of change to be expected can also result, for example from the position of the relevant image region; the rate of change may thus be low in, for example, the upper region of the image acquisition sensor in which the sky is preferably imaged. In the context of the defined sequence in which the different zones are checked, important zones can, for example, be checked more often than unimportant zones.

In an example embodiment of the method for detecting defective pixels of an image acquisition sensor, preferably in a driver assistance system, before the individual check of the pixels, an estimate is made of global features, which estimate encompasses a calculation of statistical quantitative indicators for a region under consideration, the individual check of the pixels being carried out when the change over time in the statistical quantitative indicators in the region under consideration reaches and/or exceeds a predefined fifth reference value. This feature advantageously increases interference resistance and decreases the false alarm rate. For example, the check as to whether a pixel is continuously outputting image data that represent a black or white value can be carried out only if the average grayscale value of the sensed image, or of a sensed subregion of the image in which the corresponding pixel is located, lies within a defined value range.

When continuously connected defective pixels have been detected, it is possible to detect in the sensed image, by way of a downstream plausibility check, static zones that can be caused, for example, by parts of the own vehicle or by dirt in front of the lens. These static zones normally relate to more than one individual pixel, and can be detected by the fact that a simultaneous failure of multiple adjacent pixels is highly improbable.

The time intervals for the evaluation can advantageously be predefined as a function of sensed vehicle-dynamics variables, the vehicle-dynamics variables encompassing a vehicle speed and/or a steering angle and/or a roll angle and pitch angle. A small time interval can then be set for a rate of change that is expected to be high, for example at a high vehicle speed, and a longer time interval can correspondingly be set for a rate of change that is expected to be low, for example for a low vehicle speed or when the vehicle is stationary.

Exemplifying embodiments of the invention are depicted in the drawings and will be further explained in the description that follows.

### BRIEF DESCRIPTION OF THE DRAWINGS

FIG. 1 is a schematic block diagram of an apparatus for detecting defective pixels of an image acquisition sensor, preferably in a driver assistance system.

FIG. 2 schematically depicts an image acquisition surface of an image acquisition sensor depicted in FIG. 1.

### DETAILED DESCRIPTION

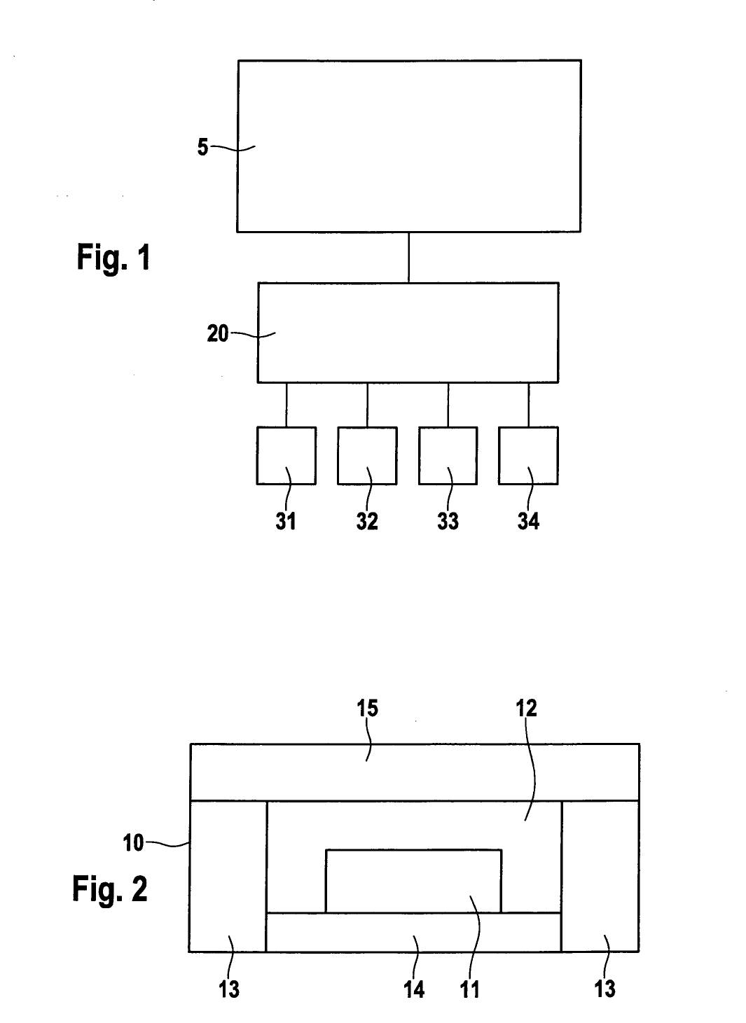

As is evident from FIG. 1, an apparatus for detecting defective pixels of an image acquisition sensor 5 in a driver assistance system encompasses an evaluation and control unit 20 that stores in a fault memory 31 the positions of those pixels of image acquisition sensor 5 that are detected as defective. In addition, evaluation and control unit 20 can evaluate data from vehicle systems 33, 34 in order to detect defective pixels, the data relating, for example, to a present vehicle speed and/or a present steering angle and/or a present roll and pitch angle of the vehicle. The pixel positions of the image acquisition sensor that are detected as defective can be outputted, for example, via an output unit 32 coupled to evaluation and control unit 20.

Evaluation and control unit 20 statistically evaluates brightness values for each pixel while image acquisition sensor 5 is operating as intended for image acquisition, without influencing ongoing operation; for statistical evaluation, evaluation and control unit 20 determines for each pixel, from the ascertained brightness values, at least one comparable parameter that is compared with at least one predefinable reference value. Evaluation and control unit 20 determines the parameters, for example, via time-sliding averaging by windowing with a constant width and/or with recursive filtration. The parameters that are determined encompass, for example, averages and/or maximum values and/or minimum values and/or maximum and/or minimum difference values and/or standard deviations of the sensed brightness values. Evaluation and control unit 20 detects a defective pixel when the at least one parameter determined for the relevant pixel meets a predefinable condition with respect to the at least one reference value.

For the detection of defective pixels, evaluation and control unit 20 encompasses a high-performance computing unit (not depicted) for image processing, and combines various algorithms that differ in terms of their complexity and effectiveness. According to a first algorithm, it is stipulated that a defective pixel of image acquisition sensor 5 appears black or white, i.e. assumes an extreme dark or light value. Evaluation and control unit 20 therefore checks the image data of all pixels, during image acquisition operation of image acquisition sensor 5, as to whether the outputted image data continuously represent a black or white value. Evaluation and control unit 20 detects a white value when the at least one parameter determined for the corresponding pixel, for example, reaches and/or exceeds a first predefined reference value, and the black value when the at least one parameter that is determined reaches and/or falls below a second predefined reference value. The first predefined reference value corresponds, for example, to a maximum brightness value, and the second predefined reference value corresponds, for example, to a minimum brightness value. Evaluation and control unit 20 carries out this check, however, only if an average grayscale value, estimated as a global feature, of the sensed image or of a subregion of the sensed image lies within a defined value range.

According to a second algorithm, evaluation and control unit 20 evaluates a difference between chronologically successive identical parameters for each pixel. Evaluation and control unit 20 detects a defective pixel when the ascertained difference reaches and/or falls below a predefined third reference value over a predefined time period, i.e. when the difference between chronologically successive brightness values of a pixel no longer differ or differ only insignificantly.

According to a third algorithm, it is stipulated that the time dynamic of the brightness fluctuations that act on image acquisition sensor 5 during operation thereof is approximately the same for directly adjacent pixels. It can be assumed that these conditions are always met during normal vehicle operation (not necessarily with the vehicle at a standstill) because of the relative motion between the vehicle and the scenery being imaged. Evaluation and control unit 20 compares the at least one parameter determined for each pixel with the same at least one parameter determined for the adjacent pixels. If a long-lasting significant deviation is detected, evaluation and control unit 20 infers a defective pixel. This means that evaluation and control unit 20 infers a defective pixel when differences between the at least one ascertained parameter for the corresponding pixel and the relevant ascertained parameters for its adjacent pixels reach and/or exceed a predefined fourth reference value.

In order to economize on computer resources, the algorithms described can be applied successively to mutually adjoining subregions of the entire image region 10 of image acquisition sensor 5. For evaluation of the adjacent pixels, for example, an analysis window having a predefinable number of pixels can be used, which window is shifted in steps over image region 10 of image acquisition sensor 5. The smallest reasonable region encompasses three pixels that are disposed next to one another in a row or a column. This “analysis window” can then progressively be shifted over the entire image region 10 so that at the end of the pass, each pixel has been evaluated. As a result of the analysis window, detection of a spontaneously occurring pixel defect requires several frames or images. This is not critical for many applications, however, since the effects of a pixel defect normally do not result in immediate failure of the associated driver assistance system or vehicle system 33, 34.

In addition, as is apparent from FIG. 2, image region 10 of image acquisition sensor 5 can be divided into different zones, preferably into five different zones 11, 12, 13, 14, 15, that are examined separately for defective pixels and checked one after another in a defined sequence. The division is made, for example, as a function of the importance and/or the expected rate of change in brightness. Zones 11, 12, 13, 14, 15 are checked one after another in the defined sequence; important zones 11, 12, which are disposed at the center of the image, are checked more often than unimportant zones 12, 13, 14 that are disposed in edge regions of image region 10. In addition, the various zones 11, 12, 13, 14, 15 can be checked as a function of the rate of change to be expected; a zone 15, which is located in the upper image region 10 and preferably images the sky, exhibits a lower rate of change and therefore need not be checked so often. According to one possible sequence, the five defined zones 11, 12, 13, 14, 15 are checked within one checking cycle, for example, in such a way that zone 11 is checked every second time, zone 12 every fourth time, zone 13 every eighth time, and zones 14 and 15 each every sixteenth time. It is advantageous in this context that the number, location, and/or size of zones 11, 12, 13, 14, 15 can be defined as a function of a concrete application and/or of a freely selectable diagnosis pattern.

In order to increase interference resistance and achieve a lower false alarm rate, checks can be made which identify whether a check can be performed with a sufficiently high reliability or probability of detecting a pixel defect. This is done, for example, by way of an upstream estimation of global features that are suitable for the calculation of statistical quantitative indicators for an expanded vicinity of image points or image segments under consideration. If the change over time in the statistical quantitative indicators in the regions considered does not exceed a threshold value, it is not useful to carry out the individual-pixel checks in those regions.

If multiple continuously connected defected pixels are detected, a plausibility check can then follow; this also enables a detection of static regions within image region 10, since a simultaneous failure of multiple adjacent pixels is highly improbable. The static zones can be caused, for example, by parts of the own vehicle or by dirt in front of the objective.

In addition, the time intervals that are used to determine or to evaluate the parameters of the brightness values can be predefined as a function of sensed vehicle-dynamics variables, the vehicle-dynamics variables preferably encompassing a vehicle speed and/or a steering angle and/or a roll and pitch angle. In principle, all available vehicle-dynamics variables that affect the field of view of the camera can be utilized. If a large rate of change is expected, e.g. in the context of a high present vehicle speed, a small time interval can be predefined. If a small rate of change is expected, e.g. in the context of a low present vehicle speed, a larger time interval can correspondingly be predefined.

1-11. (canceled)

12. A method for detecting defective pixels of an image acquisition sensor, comprising:
statistically evaluating brightness values for each pixel while the image acquisition sensor is being operated as intended for image acquisition;
determining at least one comparable parameter for statistical evaluation for each pixel from the ascertained brightness values;
comprising the at least one parameter with at least one predefinable reference value; and
detecting a defective pixel when the at least one parameter determined for the pixel meets a predefinable condition with respect to the at least one reference value.

13. The method according to claim 12, wherein the image acquisition sensor is arranged in a driver assistance system.

14. The method according to claim 12, wherein the parameters are determined from sensed brightness values via time-sliding averaging at least one of (i) by windowing with at least one of (a) a constant and (b) a variable width and (ii) with recursive filtration, the determined parameters encompassing at least one of (a) averages, (b) maximum values, (c) minimum values, (d) maximum difference values, (e) minimum difference values, and (f) standard deviations.

15. The method according to claim 12, wherein a defective pixel is detected when the at least one parameter determined for the corresponding pixel at least one of (i) at least one of (a) reaches and (b) exceeds a first predefined reference value and (ii) at least one of (a) reaches and/(b) falls below a second predefined reference value, the first predefined reference value corresponding to a maximum value and the second predefined reference value to a minimum value.

16. The method according to claim 12, wherein a difference between chronologically successive identical parameters for each pixel is evaluated, a defective pixel being detected when the ascertained difference at least one of (a) reaches and (b) falls below a predefined third reference value over a predefined period of time.

17. The method according to claim 12, wherein at least one ascertained parameter for each pixel is compared with the same at least one ascertained parameter of the adjacent pixels, a defective pixel being inferred when differences between the at least one ascertained parameter of the corresponding pixel, and the ascertained parameters of its adjacent pixels, at least one of (a) reach and (b) exceed a predefined fourth reference value.

18. The method according to claim 17, wherein for analysis of the adjacent pixels, an analysis window having a predefinable number of pixels is used, which window is shifted in steps over an image region of the image acquisition sensor.

19. The method according to claim 12, wherein an image region of the image acquisition sensor is divided, as a function of at least one of (a) importance and (b) a rate of change to be expected, into different zones that are checked successively in a defined sequence.

20. The method according to claim 12, wherein before the individual check of the pixels, an estimate is made of global features, which estimate encompasses a calculation of statistical quantitative indicators for a region under consideration, the individual check of the pixels being carried out when the change over time in the statistical quantitative indicators in the region under consideration at least one of (a) reaches and (b) exceeds a predefined fifth reference value.

21. The method according to claim 12, wherein a plausibility check is carried out when multiple continuously connected defective pixels have been detected, the plausibility check also providing a detection of static regions within the image region.

22. The method according to claim 12, wherein at least one of (a) time intervals for the determination and (b) evaluation of the parameters is predefined as a function of sensed vehicle-dynamics variables, the vehicle-dynamics variables encompassing at least one of (a) a vehicle speed, (b) a steering angle and (c) a roll angle and pitch angle.

23. An apparatus for detecting defective pixels of an image acquisition sensor in a driver assistance system, comprising:
an evaluation and control unit adapted to perform a method including:
statistically evaluating brightness values for each pixel while the image acquisition sensor is being operated as intended for image acquisition;
determining at least one comparable parameter for statistical evaluation for each pixel from the ascertained brightness values;
comprising the at least one parameter with at least one predefinable reference value; and
detecting a defective pixel when the at least one parameter determined for the pixel meets a predefinable condition with respect to the at least one reference value.
